(19) United States
(12) Patent Application Publication
(10) Pub. No.: US 2004/0027413 A1
(43) Pub. Date: Feb. 12, 2004

(54) Tractor feed imaging system and method for platesetter

(75) Inventors: James J. Hebert, Manchester, NH (US); Edward P. Kozlowsky, Auburn, MA (US)

Correspondence Address: AGFA CORPORATION, LAW & PATENT DEPARTMENT, 200 BALLARDVALE STREET, WILMINGTON, MA, 01887, US

(73) Assignee: Agfa Corporation, Wilmington, MA (US)

(21) Appl. No.: 10/215,569

(22) Filed: Aug. 9, 2002

(51) Int. Cl. B41J 23/00

(52) U.S. Cl. 347/37; 347/105

(57) ABSTRACT

An imaging engine for a platesetter comprises an imager for exposing a line of the plate that extends transversely across the plate. The plate is supported on a belt adjacent to the imager. The belt moves the plate to scan the line from the imager laterally across the plate. A vacuum platen is provided under the belt to pull the plate against the belt. The belt is the preferably porous to transfer the vacuum provided by the platen to the plate, to thereby pull the plate against the belt. Variable depth vacuum grooves can be utilized to provide a more constant vacuum across the platen. The belt is preferably supported by a first roller and a second roller that tension the belt under the imager. A detent system is provided to lock the rotation of the rollers to the movement of the belt. In this way, by using a high precision encoder in the drive motor, the belt can be positioned to the resolutions required for high resolution imaging of the plate.

### BACKGROUND OF THE INVENTION

Imagesetters and platesetters are used to expose the printing substrates that are used in many conventional offset printing systems. Imagesetters are typically used to expose the film that is then used to make the plates for the printing system. Platesetters are used to directly expose the plates.

For example, plates are typically large substrates that have been coated with photosensitive or thermally-sensitive material layers, referred to as the emulsion. For large run applications, the plates are fabricated from aluminum, although organic plates, such as polyester or paper, are also available for smaller runs.

Computer-to-plate printing systems are used to render digitally stored print content onto these plates. Typically, a computer system is used to drive an imaging engine of the platesetter.

The imaging engine selectively exposes the emulsion that is coated on the plates. After this exposure, the emulsion is developed so that during the printing process, inks will selectively adhere to the plate's surface to transfer the ink to print medium.

Most conventional systems expose the media by scanning. In a common implementation, the plate or film media is fixed to the outside or inside of a drum and then scanned with a laser source in a raster fashion. The laser's spot is moved longitudinally along the drum's axis, while the drum is rotated under the spot. As a result, by modulating the laser, the media is selectively exposed in a continuous helical scan.

Another, less common configuration utilizes a step and repeat exposure system. The plate is exposed in a number of smaller fields in the fashion of a grid pattern. The fields are distributed across the plate's surface. The imaging engine successively steps between each of these fields, exposing the fields with the desired image.

### SUMMARY OF THE INVENTION

Each of these basic system configurations has different drawbacks. The most common drum configurations can be expensive to manufacture. The drum, for example, must be large enough to hold the largest format plate that the machine is required to accept. It is a very high precision component that must spin on a well centered axis to avoid any variation in the distance between the drum's surface and the imager of the imaging engine, since these imagers tend to have very short depths of focus. Even small variations in the drum's axis of rotation can result in deterioration in the system's resolution. The drums must further have sophisticated clipping systems for holding the plates firmly to the drum. Typically, this is augmented with a vacuum system to further ensure good contact between the drum and the substrate across the entire time required to expose the substrate.

Step and repeat systems avoid some of these drawbacks, but can be susceptible to stitching errors both in terms of exposure and alignment. The human eye can detect even small changes in exposure if it results in a line across the media.

The present invention is directed to an imaging engine for a platesetter. It comprises an imager for exposing a line of the plate that extends transversely across the plate.

Different from conventional platesetters, however, is the fact that the plate is supported on a belt adjacent to the imager. The belt moves the plate to scan the line from the imager laterally across the plate.

In this way, a relatively inexpensive belt can be used to support the media. The necessity of a drum, and associated clip and vacuum systems, can be avoided. In the same way, however, problems associated with step and repeat systems are avoided since the scanning process is very analogous that used in this conventional drum scanning devices.

Depending on the implementation, the imager can be a swath scanner or a flat field type scanner.

In the preferred embodiment, a vacuum platen is provided under the belt to pull the plate against the belt. The belt is the preferably porous to transfer the vacuum provided by the platen to the plate. Variable depth vacuum grooves can be utilized to provide a more constant vacuum across the platen.

The belt is preferably supported by a first roller and a second roller that tension the belt under the imager. A detent system use sometimes used to lock the rotation of the rollers to the movement of the belt. In this way, by using a high precision encoder in the drive motor, the belt can be positioned to the resolutions required for high resolution imaging of the plate.

In general, according to another aspect, the invention features a method of operation for an imaging engine of a platesetter. The method comprises supporting a plate on a belt adjacent to an imager. The imager then exposes lines of the plate that extend transversely across the plate. The plate is scanned underneath the imager by driving the belt in the direction that is transverse to the lines of the imager.

Depending on the implementation, the scan can have a continuous or step wide movement profile.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic, side plan view of the platesetter imaging engine, according to the present invention;

FIG. 2 is a schematic top plan view of the inventive platesetter imaging engine; and

FIG. 3 is a perspective view of the belt system, according to the present invention.

### DETAILED DESCRIPTION OF THE PREFERRED EMBODIMENTS

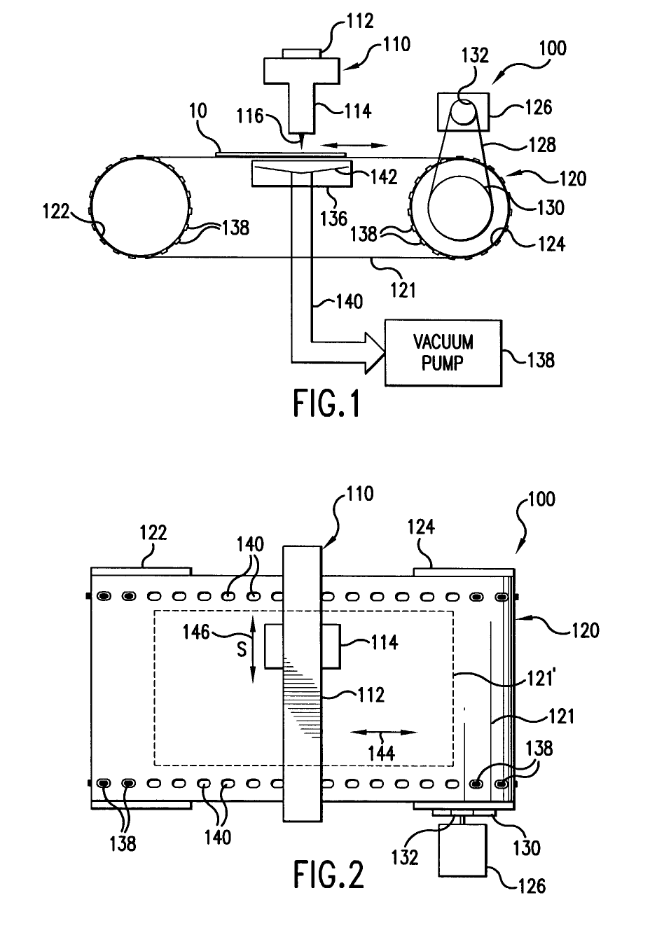

FIG. 1 shows an imaging engine 100 for a platesetter, which has been constructed according to the principles of the present invention.

In general, the imaging engine 100 comprises an imager 110 and a belt system 120.

The imager 110 generally comprises an optical signal generator portion 114. This generates, typically, a modulated laser beam 116 that is used to expose the plate or substrate 10 with the desired image. The optical signal generator 114 is supported on a frame or track member 112 so that it is held adjacent to the plate 10 with a stable mechanical relationship.

The belt system 120 generally comprises a belt 121. The belt 121 extends between a first roller 122 and a second roller 124. One of the rollers 122, 124 is preferably driven by a motor encoder system 126. In the illustrated embodiment, a belt or chain 128 extends between a gear 130 of the second roller 124 and a motor drive gear 132. In this way, the motor encoder 126 is configured to drive the first roller 124 and thereby move the belt 121 in a precise fashion underneath the optical signal generator 114.

In the preferred embodiment, a stable relationship between the plate 10 and the belt 121 is achieved through the use of a vacuum platen 136. Specifically, a vacuum pump 138 is used to generate a vacuum that is conveyed to the vacuum platen 136 via vacuum line 140. The vacuum platen 136 has a series of vacuum grooves 142 that are machined in the body of the vacuum platen 136. The vacuum provided to these groove 142 acts to pull the belt 121 against the vacuum platen. The belt 121 is porous to air. In the preferred embodiment, the belt 121 is manufactured from a sheet metal with a matrix of small holes. As a result, the vacuum provided by the vacuum platen 136 is therefore transferred to the plate 10 so that the plate 10 is pulled into a rigid mechanical engagement with the belt 121.

It is important to note that generally the level of the vacuum provided by the vacuum pump 138 must not be too high. The vacuum acts on the belt to a certain extent. If a very high vacuum is used, it can result in excessive friction between the belt 121 and the upper surface of the vacuum platen 136. This can result in excessive wear.

With reference to FIGS. 1 and 2, the controlled movement of the plate 10 under the optical signal generator 114 of the imager 110 further requires a stable, mechanical relationship between the belt 121 and the rollers 122, 124.

This is achieved in the preferred embodiment by using a series of pins 138 on each of the first roller 122 and the second roller 124. These pins or projections engage with cut out portions 140 that are formed in the backside of the belt 121. These cut outs are preferably holes that extend entirely through the sheet metal of the belt 121.

The combination of these pins or projections 138 and the cut out regions 140 provide a detent system that prevents slippage between the rollers 122, 124 and the belt 121 so that the motor encoder 126 can be driven to precisely position the substrate 10 relative to the optical signal generator 114.

A number of different implementations of the imager 110 are possible. In one example, the imager 110 is a swath scanner. Typically, in this implementation, the scanner comprises a combination of a beam generator, a spinning polygon, and an F-THETA lens. The spinning polygon has the effect of scanning the laser beam from the beam generator, in a line, across the surface of the plate 10, see arrow 146. This direction that is perpendicular to the plate's direction of movement, see arrow 144. The F-THETA lens equalizes the optical distance the beam propagates so that it is constant across the entire scan. This compensates for the short depth of focus in the typical high resolution scanning system. In an alternative implementation, a flat field scanner is used. In this example, the optical signal generator 114 travels back and forth in the direction of arrow 146, along a track on the support 112. It thus works in the fashion of a plotter to expose successive lines of the plate 10 that extend across the plate.

In the case of the swath scanner, the plate 10 is typically moved by a controller in a continuous fashion underneath the optical signal generator under the control of the motor encoder 126.

In the case of the flat field scanner, the motor encoder 126 with the controller typically drives the plate 10 underneath the optical signal generator 114 in a stepwise fashion.

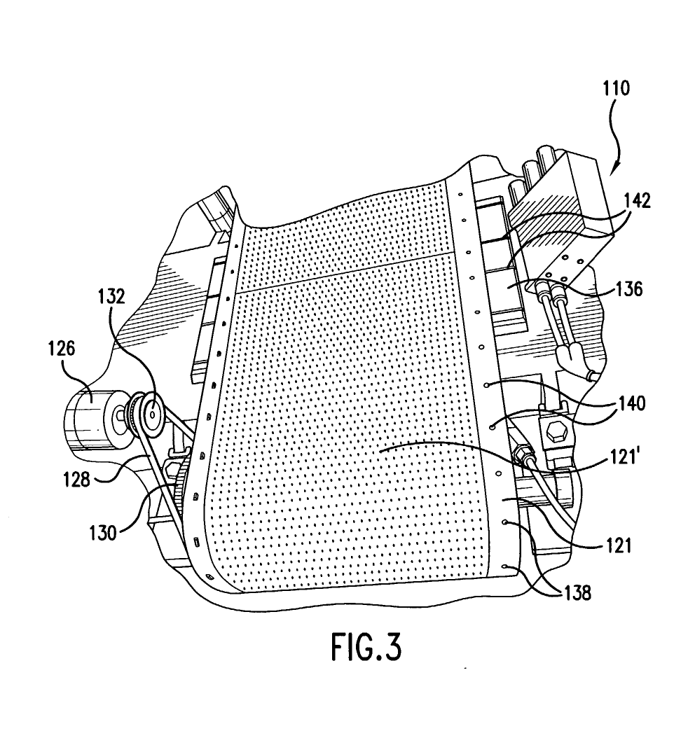

FIG. 3 is a perspective view showing the belt 121 and specifically, it porous surface. Specifically, at least in the region 121′, the belt 121 has a series of holes that render the belt porous to the vacuum. In this example, the porous portion 121′ of the belt 121 covers the entire surface of the belt, extending between the line of cut outs 140 on each side of the belt.

While this invention has been particularly shown and described with references to preferred embodiments thereof, it will be understood by those skilled in the art that various changes in form and details may be made therein without departing from the scope of the invention encompassed by the appended claims.

What is claimed is:

1. An imaging engine of a platesetter, comprising:
an imager for exposing a line of a plate that extends transversally across the plate; and
belt for supporting the plate adjacent to the imager for moving the plate to scan the line from the imager laterally across the plate.

2. An imaging engine as claimed in claim 1, wherein the imager is a swath scanner.

3. An imaging engine as claimed in claim 1, wherein the imager is a flat field scanner.

4. An imaging engine as claimed in claim 1, further comprising a vacuum platen under the belt for pulling the plate against the belt.

5. An imaging engine as claimed in claim 4, wherein the belt is porous to transfer a vacuum provided by the platen to the plate to pull the plate against the belt.

6. An imaging engine as claimed in claim 4, wherein the vacuum platen comprises variable depth vacuum grooves for providing a more constant vacuum level across the platen.

7. An imaging engine as claimed in claim 1, further comprising a first roller and a second roller for tensioning and supporting the belt under the imager.

8. An imaging engine as claimed in claim 7, further comprising a detent system of the belt and the first and second rollers for locking rotation of the rollers to movement of the belt.

9. An imaging engine as claimed in claim 8, wherein the detent system comprises projections extending circumferentially around at least one of the rollers that engage cut-out portions of the belt.

10. An imaging engine as claimed in claim 1, wherein the belt is metal.

11. An imaging engine as claimed in claim 1, wherein the belt is fabricated from sheet metal.

12. A method of operation for an imaging engine of a platesetter, the method comprising:
supporting a plate on a belt adjacent to an imager;
the imager exposing lines of the plate that extend across the plate; and
scanning the plate underneath the imager by driving the belt in a direction that is at least partially transverse to the lines of the imager.

13. A method as claimed in claim 12, wherein the step of the imager exposing lines of the plate comprises the imager scanning a beam across the plate.

14. A method as claimed in claim 12, wherein the step of the imager exposing lines of the plate comprises the imager moving across the plate on a track.

15. A method as claimed in claim 12, further comprising establishing a vacuum under the plate to pull the plate into engagement with the belt.

16. A method as claimed in claim 15, further comprising transferring the vacuum through the belt.

17. A method as claimed in claim 12, further comprising establishing a substantially uniform vacuum under the plate to pull the plate into engagement with the belt.

18. A method as claimed in claim 12, further comprising supporting the belt between two rollers.

19. A method as claimed in claim 18, further comprising locking the belt to at least one of the rollers.

20. A method as claimed in claim 12, further comprising driving the belt in a stepwise fashion.

21. A method as claimed in claim 12, further comprising driving the belt in a continuous fashion.
